(19) United States
(12) Patent Application Publication
(10) Pub. No.: US 2024/0059129 A1
(43) Pub. Date: Feb. 22, 2024

(54) Automotive Sun Side Safe Screen

(71) Applicants: Edib Sabitov, Georgetown, TX (US); Nicolas Lukashevich, Rockwall, TX (US)

(72) Inventors: Edib Sabitov, Georgetown, TX (US); Nicolas Lukashevich, Rockwall, TX (US)

(21) Appl. No.: 17/820,327

(22) Filed: Aug. 17, 2022

(51) Int. Cl. B60J 3/00

(52) U.S. Cl. CPC B60J 3/007

(57) ABSTRACT

The primary object of the invention is to filter a percentage of light from the upper section of a vehicles side window in such a way that it does not impede view of the side mirrors or surroundings. This is accomplished by attaching or adhering a filtering material from the upper portion of the window in a determined shape. The invention can be attached permanently or temporarily to the desired window. The shape of the filtering material will be determined based on the dimensions of the front side windows in order to provide the most protection from the sun while allowing the side mirrors and near surroundings to be seen. The invention will be configurable based on the specific dimensions of each motor vehicle.

### BACKGROUND OF INVENTION

### 1. Field of the Invention

The present invention relates to side window light filtration devices in motor vehicles.

### 2. Description of Related Art

Many products exist on the market for reducing the transmission of light into vehicles. Some of these products are installed by the individual or businesses, while others come from the manufacturers. Most of these products cover the whole side window. By providing such extensive coverage the visibility form within the vehicle of side mirrors and the surroundings is diminished during the day and night. The most common solutions to the safety limitations of covering the whole window have been to increase the amount of light that can pass through these filters. Such solutions have made the filtering ineffective in protecting the driver or passengers from lateral sunlight or reflections from things such as snow.

Other products such as sunshades or suction cup attachable filters usually come in rigid rectangular shapes which fail to accommodate the wide variety of geometrical shapes of windows. This failure to address the variability in windows makes them prone to gaps in coverage or simply not suitable for certain window shapes. The bulk of some of these devices prevents the window to be rolled down with them still attached. Additionally, the suction cups commonly used in such devices are unreliable and decrease in efficacy either from continuous reattachment or from changes in temperature on the glass.

The invention solves a variety of problems of previous light filtering devices. The invention is customizable to the specific measurements of each vehicle window. The invention does not cover the whole window, but leaves enough area underneath uncovered so the driver or passenger can see their surroundings. The invention allows the window to be rolled down in case of an emergency.

### SUMMARY OF THE INVENTION

This invention relates to a detachable or permanent apparatus for reducing the transmission of light from the front side windows of a motor vehicle.

The primary object of the invention is a method and device for protecting a car driver and or passenger from direct or indirect sunlight passing through front or back side windows. Low direct sunlight after sunrise, before sunset, and wintertime can blind a car driver and thus create dangerous driving conditions.

The primary object of the invention is to filter a percentage of light from the upper section of a vehicles side window in such a way that it does not impede view of the side mirrors or surroundings. The invention can cover anywhere up to 40% of the surface area of the side window. This is accomplished by attaching or adhering a filtering material from the upper portion of the window in a determined shape. The invention can be attached permanently or temporarily to the desired window. The shape of the filtering material will be determined based on the dimensions of the front side windows in order to provide the most protection from the sun while allowing the side mirrors and near surroundings to be seen. The invention will be configurable based on the specific dimensions of each motor vehicle, and the legal requirements for tinting in each jurisdiction.

A further object of the invention is to provide enough filtering of direct and lateral sunlight from either sun, snow, or other reflective materials for the safe and comfortable operation of a motor vehicle. The percentage of filtered light will vary depending on the material used in the invention and the homogeneity of the filtering material. For example the use electrochromic filters.

Another object of the invention is for it to remain in place even when the window is lowered.

### DESCRIPTION OF THE DRAWINGS

The relevant aspects of the invention and the advantages it has will be better understood by reference to the following descriptions accompanied with the drawings.

FIG. 1. Shows a side view of a sedan style motor vehicle with the invention attached to the front window for a driver with less than average height.

FIG. 2. Shows a side view of a truck style motor vehicle with the invention attached to the front window for a driver with average height.

FIG. 3. Shows a side view of a van style motor vehicle with the invention attached to the front window for a driver with more than average height.

### DETAILED DESCRIPTION

The detailed description set forth with the drawings are intended as a description of the various embodiments of the invention, and not intended to represent the only embodiments. Each description is set forth to illustrate and provide an example of the invention and not to preclude other uses and embodiments of the invention. The examples in this description are not intended to be exhaustive of the embodiments of the invention.

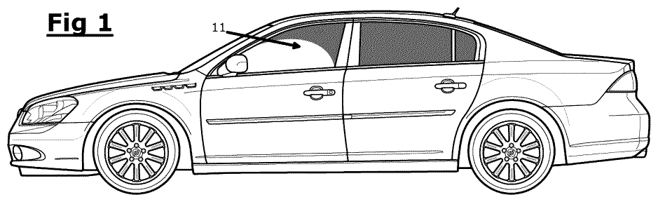

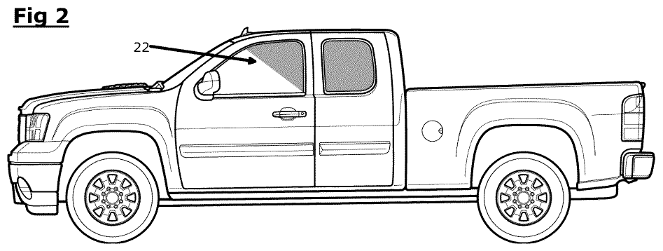

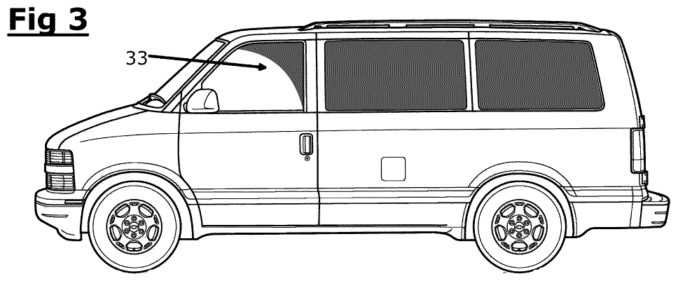

Referring to FIGS. 1-3. Show a side view of a vehicle. On the vehicle window is illustrated an example of an embodiment of the invention 11, 22, 33. In this example the invention covers less than 40% of the surface area of the window and allows an average height seated driver to view the side mirror without the invention obstructing the view. In this example the passenger also has a clear view of the nearby surroundings under the invention. In the embodiment depicted a viewer may perceive that the invention attaches from the top of the window in order to block lateral sunlight or light reflections. In the embodiment depicted a viewer may perceive that the geometrical dimensions of the invention are derived from the particular shape of the window itself and can be altered depending on the type of vehicle or preference of the occupants.

1. An apparatus for reducing the transmission of light from the side windows of a vehicle, comprising:
(a) A material of light filtration qualities to reduce the transmission of light.
(b) A shape determined by the dimensions of the side window of the vehicle.
(c) A surface area of no more than 40% of the window.
(d) An attachment mechanism to the inside side of the window.

2. The apparatus of claim 1 in which the filtering material has a visible light transmission (VLT) from 5 to 90 percent.

3. The apparatus from claim 1 in which the shape does not impede a seated passenger of average height adjacent to the window from observing the side mirror.

4. The apparatus from claim 1 in which the thickness allows for the normal operation of raising or lowering the window.

5. The apparatus from claim 1 in which the attachment mechanism is applied to one side of the apparatus and allows for temporary or permanent installation of the apparatus to the inside of the window.

6. The apparatus from claim 1 in which the attachment mechanism is applied to one side of the window and allows for temporary or permanent installation of the apparatus to the inside of the window.
